(19) United States
(12) Patent Application Publication
(10) Pub. No.: US 2026/0205527 A1
(43) Pub. Date: Jul. 16, 2026

(54) METHOD AND SYSTEM FOR PROVIDING STRUCTURAL CONFORMITY TO MORE THAN ONE TYPE OF ELECTRONIC TRANSMISSION WITHIN A NETWORK

(71) Applicant: JPMorgan Chase Bank, N.A., New York, NY (US)

(72) Inventors: Amalesh PRADHAN, Plano, TX (US); Shailesh SINGH, Frisco, TX (US)

(73) Assignee: JPMorgan Chase Bank, N.A., New York, NY (US)

(21) Appl. No.: 19/020,610

(22) Filed: Jan. 14, 2025

(51) Int. Cl. H04L 69/18

(52) U.S. Cl. CPC H04L 69/18

(57) ABSTRACT

A system is presented that provides transmission type-based structural conformity to electronic transmissions within an electronic transmission network. The system may be configured to identify definitions that govern more than one type of electronic transmission structure, produce respectively corresponding models of the more than one type of electronic transmission structure, register the respectively corresponding models within an enterprise-wide catalog of electronic transmission structure types; obtain a first request for a first type of electronic transmission; utilize the enterprise-wide catalog of electronic transmission structure types to structure an electronic transmission according to a first model of the first type of electronic transmission; and transmit the electronic transmission via the electronic transmission network.

### BACKGROUND

### 1. Field

This disclosure generally relates to electronic transmission structures and, more particularly, to a method, system, and computer-readable medium for providing structural conformity to more than one type of electronic transmission within at least one electronic transmission network. 2. Background

In today's electronic communication networks, electronic devices communicate by transmitting electronic signals to one another. These transmissions can be implemented in many different forms over a variety of different mediums, such as electrons within a conductor, electromagnetic waves radiating through space, and photons within an optical fiber, just to name a few examples.

Conventional technology typically utilizes such electronic signals to provide media services, communication services, data processing services, and a wide array of other services to its users. However, the proper implementation of these services requires that their transmissions meet certain specifications in order for them to be effective. Many modern electronic transmission specifications may require that the architecture of their transmissions includes a header that is followed by a payload, but requirements can vary, and failing to meet such requirements leads to issues such as incompatibility and even inoperability.

In addition, compatibility and interoperability issues have grown to become a huge concern in this field due to the plethora of new and existing electronic signals (and electronic signal specifications) that are now available for use. Therefore, there is a need in the field of the present disclosure for a technical improvement that solves the compatibility and interoperability concerns that are raised by the large variety of electronic signals that are being implemented in today's electronic transmission networks.

Accordingly, the herein-disclosed technology is presented to improve existing technology by providing it with a technical solution to the above-mentioned compatibility and interoperability issues of existing electronic transmission networks.

### SUMMARY

The present disclosure, through one or more of its various aspects, embodiments, and/or specific features or sub-component, provides, inter alia, various systems, servers, devices, methods, media, programs and platforms for providing transmission type-based structural conformity to electronic transmissions within at least one electronic transmission network.

According to an aspect of the present disclosure, a method is presented for providing transmission type-based structural conformity to electronic transmissions within at least one electronic transmission network. The method may comprise identifying a first set of definitions that govern a first set of electronic transmission structure types, producing a first set of respectively corresponding models of the first set of electronic transmission structure types, and registering the first set of respectively corresponding models within an enterprise-wide catalog of electronic transmission structure types.

The method may further comprise obtaining a first request for a first type of at least one electronic transmission, utilizing the enterprise-wide catalog of electronic transmission structure types to structure the at least one electronic transmission according to a first model of the first type of the at least one electronic transmission, and transmitting the at least one electronic transmission via the at least one electronic transmission network according to the first request. The first set of respectively corresponding models may comprise the first model of the first type of the at least one electronic transmission

In the method, the registering may comprise publishing the first set of respectively corresponding models to at least one from among a public schema and an external schema, and receiving at least one corresponding electronic network transmission from at least one external electronic transmission network process. The at least one external electronic transmission network process may utilize the at least one from among the public schema and the external schema, to structure the at least one corresponding electronic network transmission according to the first model of the first type of the at least one electronic transmission.

In the method, the first set of respectively corresponding models may comprise a first set of definitions that govern a first set of at least one type of electronic transmission structure from among the following electronic transmission structure types: an application programing interface (API) transmission, a file transmission, a user interface (UI) transmission, a media transmission, a hypertext transfer protocol (HTTP) transmission, and a transmission control protocol (TCP) transmission.

In the method, the first set of definitions may comprise at least one from among a naming convention definition, a required access permission definition, and a transmission retention duration definition.

In the method, the producing may comprise utilizing at least one data modeling tool to produce the first set of respectively corresponding models of the first set of electronic transmission structure types.

In the method, the at least one data modeling tool may be configured to utilize JavaScript object notation (JSON) to produce the first set of respectively corresponding models.

In the method, the first set of definitions may be obtained from at least one relational database that stores a first set of Java ARchive (JAR) files that provide a first set of respectively corresponding records that collectively govern at least one operation of the at least one electronic transmission network.

In the method, the first set of definitions may correspond to a public application programing interface (API) protocol.

The method may further comprise receiving at least one from among a new definition and an updated definition that comprises at least one modification to the first set of definitions that govern the first set of electronic transmission structure types, and utilizing the at least one from among the new definition and the updated definition, to incorporate the at least one modification into the first set of respectively corresponding models of the first set of electronic transmission structure types.

According to another aspect of the present disclosure, a system is presented for providing transmission type-based structural conformity to electronic transmissions within at least one electronic transmission network. The system may comprise a processor and memory storing instructions that, when executed by the processor, cause the processor to perform operations. The operations may comprise identifying a first set of definitions that govern a first set of electronic transmission structure types, producing a first set of respectively corresponding models of the first set of electronic transmission structure types, and registering the first set of respectively corresponding models within an enterprise-wide catalog of electronic transmission structure types.

In the system, when executed, the instructions may cause the processor to perform further operations, which may comprise obtaining a first request for a first type of at least one electronic transmission, utilizing the enterprise-wide catalog of electronic transmission structure types to structure the at least one electronic transmission according to a first model of the first type of the at least one electronic transmission, and transmitting the at least one electronic transmission via the at least one electronic transmission network according to the first request. The first set of respectively corresponding models may comprise the first model of the first type of the at least one electronic transmission.

In the system, when the instructions are executed by the processor, the registering may comprise publishing the first set of respectively corresponding models to at least one from among a public schema and an external schema, and receiving at least one corresponding electronic network transmission from at least one external electronic transmission network process. The at least one external electronic transmission network process may utilize the at least one from among the public schema and the external schema, to structure at least one corresponding electronic network transmission according to the first model of the first type of the at least one electronic transmission

In the system, wherein when the instructions are executed by the processor, the first set of respectively corresponding models may be configured to comprise a first set of definitions that govern a first set of at least one type of electronic transmission structure from among the following electronic transmission structure types: an application programing interface (API) transmission, a file transmission, a user interface (UI) transmission, a media transmission, a hypertext transfer protocol (HTTP) transmission, and a transmission control protocol (TCP) transmission.

In the system, when the instructions are executed by the processor, the first set of definitions may be configured to comprise at least one from among a naming convention definition, a required access permission definition, and a transmission retention duration definition.

In the system, when the instructions are executed by the processor, the producing may comprise utilizing at least one data modeling tool to produce the first set of respectively corresponding models of the first set of electronic transmission structure types.

In the system, when the instructions are executed by the processor, the at least one data modeling tool may be configured to utilize JavaScript object notation (JSON) to produce the first set of respectively corresponding models.

In the system, when the instructions are executed by the processor, the first set of definitions may be obtained from at least one relational database that stores a first set of Java ARchive (JAR) files that provide a first set of respectively corresponding records that collectively govern at least one operation of the at least one electronic transmission network.

In the system, when the instructions are executed by the processor, the first set of definitions may be configured to correspond to a public application programing interface (API) protocol.

In the system, when executed, the instructions may cause the processor to perform further operations, which may comprise receiving at least one from among a new definition and an updated definition that comprises at least one modification to the first set of definitions that govern the first set of electronic transmission structure types, and utilizing the at least one from among the new definition and the updated definition, to incorporate the at least one modification into the first set of respectively corresponding models of the first set of electronic transmission structure types.

According to yet another aspect of the present disclosure, a non-transitory computer-readable medium is presented for providing transmission type-based structural conformity to electronic transmissions within at least one electronic transmission network. The computer-readable medium stores instructions that, when executed by a processor, cause the processor to perform operations. The operations may comprise identifying a first set of definitions that govern a first set of electronic transmission structure types, producing a first set of respectively corresponding models of the first set of electronic transmission structure types, and registering the first set of respectively corresponding models within an enterprise-wide catalog of electronic transmission structure types.

In the computer-readable medium, when executed, the instructions may cause the processor to perform further operations, which may comprise obtaining a first request for a first type of at least one electronic transmission, utilizing the enterprise-wide catalog of electronic transmission structure types to structure the at least one electronic transmission according to a first model of the first type of the at least one electronic transmission, and transmitting the at least one electronic transmission via the at least one electronic transmission network according to the first request. The first set of respectively corresponding models may comprise the first model of the first type of the at least one electronic transmission.

In the computer-readable medium, when the instructions are executed by the processor, the registering may comprise publishing the first set of respectively corresponding models to at least one from among a public schema and an external schema, and receiving at least one corresponding electronic network transmission from at least one external electronic transmission network process. The at least one external electronic transmission network process may utilize the at least one from among the public schema and the external schema, to structure the at least one corresponding electronic network transmission according to the first model of the first type of the at least one electronic transmission.

In the computer-readable medium, when the instructions are executed by the processor, the first set of respectively corresponding models may be configured to comprise a first set of definitions that govern a first set of at least one type of electronic transmission structure from among the following electronic transmission structure types: an application programing interface (API) transmission, a file transmission, a user interface (UI) transmission, a media transmission, a hypertext transfer protocol (HTTP) transmission, and a transmission control protocol (TCP) transmission.

In the computer-readable medium, when the instructions are executed by the processor, the first set of definitions may be configured to comprise at least one from among a naming convention definition, a required access permission definition, and a transmission retention duration definition.

In the computer-readable medium, when the instructions are executed by the processor, the producing may comprise utilizing at least one data modeling tool to produce the first set of respectively corresponding models of the first set of electronic transmission structure types.

In the computer-readable medium, when the instructions are executed by the processor, the at least one data modeling tool may be configured to utilize JavaScript object notation (JSON) to produce the first set of respectively corresponding models.

In the computer-readable medium, when the instructions are executed by the processor, the first set of definitions may be obtained from at least one relational database that stores a first set of Java ARchive (JAR) files that provide a first set of respectively corresponding records that collectively govern at least one operation of the at least one electronic transmission network.

In the computer-readable medium, when the instructions are executed by the processor, the first set of definitions may be configured to correspond to a public application programing interface (API) protocol.

In the computer-readable medium, when executed, the instructions may cause the processor to perform further operations, which may comprise receiving at least one from among a new definition and an updated definition that comprises at least one modification to the first set of definitions that govern the first set of electronic transmission structure types, and utilizing the at least one from among the new definition and the updated definition, to incorporate the at least one modification into the first set of respectively corresponding models of the first set of electronic transmission structure types.

Accordingly, the invention disclosed herein provides a novel approach to providing transmission type-based structural conformity to electronic transmissions within at least one electronic transmission network.

### BRIEF DESCRIPTION OF THE DRAWINGS

The present disclosure is further described in the detailed description which follows, in reference to the noted plurality of drawings, by way of non-limiting examples of the present disclosure, in which like characters represent like elements throughout the several views of the drawings.

FIG. 1 depicts a diagram of computer system, according to an embodiment.

FIG. 2 depicts a diagram of an environment for implementing an electronic transmission structure conformity tool, according to an embodiment.

FIG. 3 depicts a diagram of a perspective of an environment that is configured to implement an electronic transmission structure conformity tool, according to an embodiment.

FIG. 4 depicts a flowchart of a process for implementing an electronic transmission structure conformity tool, according to an embodiment.

FIG. 5 depicts a diagram of an environment for a pipeline of an electronic transmission structure conformity tool, according to an embodiment.

FIG. 6 depicts a diagram of another aspect of an environment for a pipeline of an electronic transmission structure conformity tool, according to an embodiment.

FIG. 7 depicts a diagram of details of an environment for a pipeline of an electronic transmission structure conformity tool, according to an embodiment.

FIG. 8 depicts a map of details for a pipeline of an electronic transmission structure conformity tool, according to an embodiment.

FIG. 9 depicts a map that illustrates other details for a pipeline of an electronic transmission structure conformity tool, according to an embodiment.

FIG. 10 depicts a diagram of an electronic transmission structure conformity tool module, according to an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable storage media having instructions stored thereon for one or more aspects of the present technology as described and illustrated by way of the examples herein. In some examples, the instructions include executable code that, when executed by one or more processors, cause the processors to carry out operations necessary to implement the methods of the examples of this technology that are described and illustrated herein.

As described in further detail below, the herein-disclosed technology (which may include an electronic transmission structure conformity tool) improves electronic transmission network technology by ensuring that each of its electronic transmissions that is generated, conforms to at least one of the electronic transmission networks'structural requirements.

Accordingly, by employing the herein-disclosed technology to seamlessly integrate incompatible technology into at least one electronic transmission network and thereby utilize the at least one electronic transmission network's resources, this technology provides a much-needed technical improvement to existing hardware, software and/or counterpart network technology that is found to be incompatible with the at least one electronic transmission network's structural requirements.

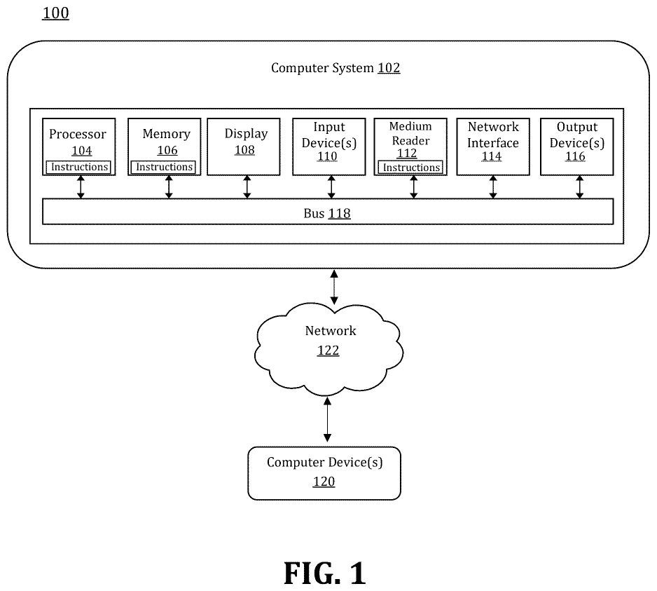

FIG. 1 is a system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for longer than a transitory period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely examples and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in a non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide methods and systems for implementing an electronic transmission structure conformity tool that provides transmission type-based structural conformity to electronic transmissions within at least one electronic transmission network.

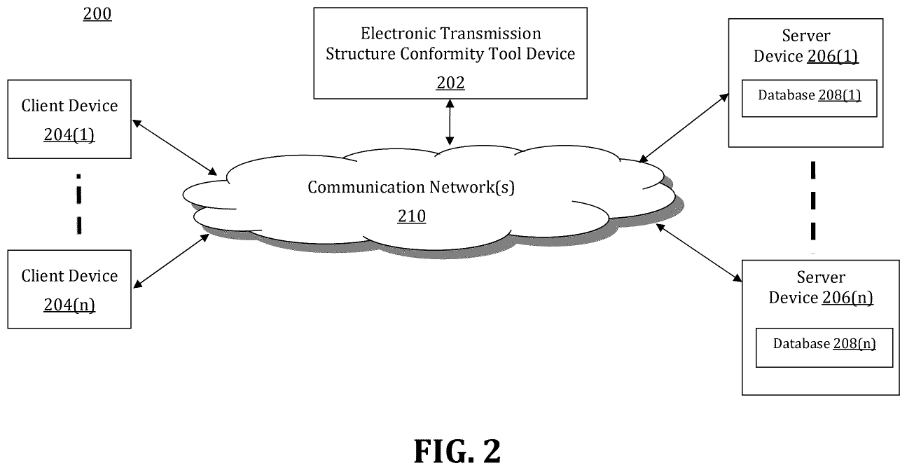

Referring to FIG. 2, a schematic of a network environment 200 for implementing an electronic transmission structure conformity tool. In an embodiment, the electronic transmission structure conformity tool may be implemented on any networked computer platform, such as, for example, a personal computer (PC).

A method for rerouting a resource transmission request, may be implemented by an electronic transmission structure conformity tool (ETSCT) device 202. The ETSCT device 202 may be the same or similar to the computer system 102 as described with respect to FIG. 1. The ETSCT device 202 may be a rack-mounted server in a datacenter, an embedded microcontroller (MCU) in an electronic device, or another type of headless system, which is a computer system or device that is configured to operate without a monitor, keyboard and mouse. The ETSCT device 202 may store one or more applications that can include executable instructions that, when executed by the ETSCT device 202, cause the ETSCT device 202 to perform actions, such as to transmit, receive, or otherwise process network communications, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the ETSCT device 202 itself, may be located in virtual server(s) running in a cloud-based computing environment rather than being tied to one or more specific physical network computing devices. Also, the application(s) may be running in one or more virtual machines (VMs) executing on the ETSCT device 202. Additionally, in one or more embodiments of this technology, virtual machine(s) running on the ETSCT device 202 may be managed or supervised by a hypervisor.

In the network environment 200 of FIG. 2, the ETSCT device 202 is coupled to a plurality of client devices 204(1)-204(n), and also to a plurality of server devices 206(1)-206(n) that hosts a plurality of databases 208(1)-208(n) via communication network(s) 210. A communication interface of the ETSCT device 202, such as the network interface 114 of the computer system 102 of FIG. 1, operatively couples and communicates between the ETSCT device 202, the client devices 204(1)-204(n), and/or the server devices 206(1)-206(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ETSCT device 202, the client devices 204(1)-204(n), and/or the server devices 206(1)-206(n) may be coupled together via other topologies. Additionally, the network environment 200 may include other network devices such as one or more routers and/or switches, for example, which are well known in the art and thus will not be described herein. This technology provides a number of advantages including methods, computer readable media, and ETSCT devices that implement a method for an electronic transmission structure conformity tool that provides transmission type-based structural conformity to electronic transmissions within at least one electronic transmission network.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like. For the purposes of the present disclosure, it should be noted that: the term “remote” may refer to a “physical” and/or “virtual” remoteness; and the term “local” may refer to a “physical” and/or “virtual” locale.

The ETSCT device 202 may be a standalone device or integrated with one or more other devices or apparatuses, such as one or more of the server devices 206(1)-206(n), for example. In one particular example, the ETSCT device 202 may include or be hosted by one of the server devices 206(1)-206(n), and other arrangements are also possible. As another example, the ETSCT device 202 may be integrated with one or more other devices or apparatuses, such as one or more of the client devices 204(1)-204(n). Moreover, one or more of the devices of the ETSCT device 202 may be in a same or a different communication network including one or more public, private, or cloud networks, for example.

The plurality of server devices 206(1)-206(n) may be the same or similar to the computer system 102 or the computer device 120 as described with respect to FIG. 1, including any features or combination of features described with respect thereto. For example, any of the server devices 206(1)-206(n) may include, among other features, one or more processors, memories and communication interfaces, which are coupled together by at least one bus or other communication link, although other numbers and/or types of network devices may be used. The server devices 206(1)-206(n) in this example may process requests received from the ETSCT device 202 via the communication network(s) 210 according to an HTTP-based and/or JavaScript Object Notation (JSON) protocol, for example, although other protocols may also be used.

The server devices 206(1)-206(n) may be hardware or software or may represent a system with multiple servers in a pool, which may include internal or external networks. The server devices 206(1)-206(n) hosts the databases 208(1)-208(n) that are configured to store data.

Although the server devices 206(1)-206(n) are illustrated as single devices, one or more actions of each of the server devices 206(1)-206(n) may be distributed across one or more distinct network computing devices that together comprise one or more of the server devices 206(1)-206(n). Moreover, the server devices 206(1)-206(n) are not limited to a particular configuration. Thus, the server devices 206(1)-206(n) may contain a plurality of network computing devices that operate using a master/slave approach, whereby one of the network computing devices of the server devices 206(1)-206(n) operates to manage and/or otherwise coordinate operations of the other network computing devices.

The server devices 206(1)-206(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 204(1)-204(n) may also be the same or similar to the computer system 102 or the computer device 120 as described with respect to FIG. 1, including any features or combination of features described with respect thereto. For example, the client devices 204(1)-204(n) in this example may include any type of computing device that can interact with the ETSCT device 202 via communication network(s) 210. Accordingly, the client devices 204(1)-204(n) may be mobile computing devices, desktop computing devices, laptop computing devices, tablet computing devices, virtual machines (including cloud-based computers), or the like, that host chat, e-mail, or voice-to-text applications, for example. In an embodiment, at least one client device 204 is a wireless mobile communication device, i.e., a smart phone.

The client devices 204(1)-204(n) may run interface applications, such as standard web browsers or standalone client applications, which may provide an interface to communicate with the ETSCT device 202 via the communication network(s) 210 in order to communicate user requests and other information. The client devices 204(1)-204(n) may further include, among other features, a display device, such as a display screen or touchscreen, and/or an input device, such as a keyboard, for example. The client devices 204(1)-204(n) may host one or more applications that are proprietary to an enterprise that may be secured from eavesdropping, and these applications may be distributed among client devices 204(1)-204(n). The enterprise's distributed applications may include software that is based on microservices architecture, for example.

Although the network environment 200 with the ETSCT device 202, the client devices 204(1)-204(n), the server devices 206(1)-206(n), the databases 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the ETSCT device 202, the client devices 204(1)-204(n), the server devices 206(1)-206(n), and the databases 208(1)-208(n), for example, may be configured to operate as virtual instances on the same physical machine. In other words, one or more of the ETSCT device 202, the server devices 206(1)-206(n), the client devices 204(1)-204(n), and the databases 208(1)-208(n) may operate on a common physical device rather than as separate devices communicating through communication network(s) 210. Additionally, there may be more or fewer client devices 204(1)-204(n), server devices 206(1)-206(n), and databases 208(1)-208(n) than illustrated in FIG. 2.

In addition, two or more computing systems, databases or devices may be substituted for any one of the systems, databases or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

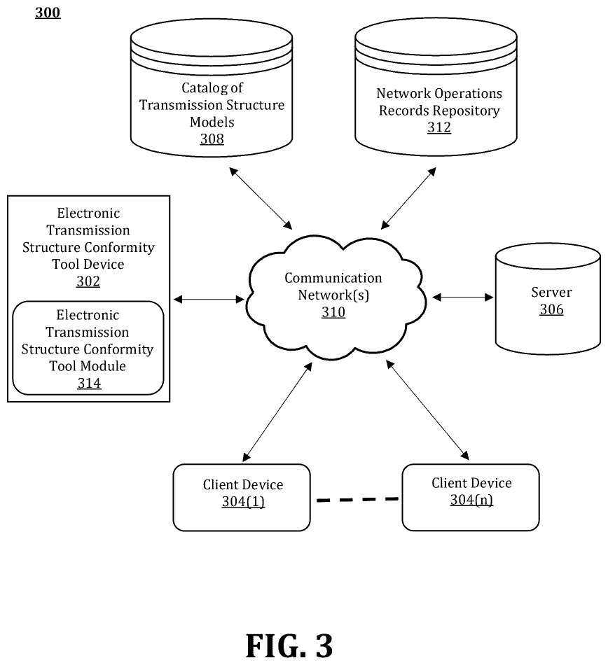

The ETSCT device 302 is described and illustrated in FIG. 3 as including electronic transmission structure conformity tool module 314, although it may include other rules, policies, modules, databases, or applications, for example. As will be described below, electronic transmission structure conformity tool module 314 is configured to provide transmission type-based structural conformity to electronic transmissions within at least one electronic transmission network, such as communication network(s) 310, for example. Electronic transmission structure conformity tool module 314 may include software that is based on microservices architecture, for example.

Electronic transmission structure conformity tool module 314 may be integrated with one or more devices or apparatuses, such as client devices 304(1)-304(n), where electronic transmission structure conformity tool module 314 may be implemented as an application or as an addon or plugin to another application of the one or more devices or apparatuses, and where electronic transmission structure conformity tool module 314 may execute in the background.

A configuration 300 for applying an electronic transmission structure conformity tool to an aspect of the network environment of FIG. 2 is illustrated as being executed in FIG. 3. Specifically, a first client device 304(1) and a second client device 304(2) are illustrated as being in communication with ETSCT device 302. In this regard, the first client device 304(1) and the second client device 304(2) may be “clients” of the ETSCT device 302 and are described herein as such. Nevertheless, it is to be known and understood that the first client device 304(1) and/or the second client device 304(2) need not necessarily be “clients” of the ETSCT device 302, or any entity described in association therewith herein. Any additional or alternative relationship may exist between either or both of first client device 304(1), second client device 304(2) and ETSCT device 302.

Electronic transmission structure conformity tool module 314 of ETSCT device 302 may communicate with at least one database, such as a catalog of transmission structure models 308. ETSCT device 302 may utilize catalog of transmission structure models 308 to ensure that electronic transmissions meet at least one electronic transmission network's structural requirements. In addition, electronic transmission structure conformity tool module 314 of ETSCT device 302 may also communicate with a network operations records repository 312. ETSCT device 302 may utilize contents of network operations records repository 312 to produce at least one model from among catalog of transmission structure models 308.

In an embodiment, electronic transmission structure conformity tool module 314 may be configured to provide a dynamically customizable interface for selecting, to communicate with, at least one server device at least one from among server devices 306(1)-306(n). Moreover, ETSCT device 302 may receive and transmit data via communication network(s) 210. ETSCT device 302 may receive and transmit data such as code that is written in one or more of the following dialects: transaction control language (TCL), data manipulation language (DML), data control language (DCL) and data definition language (DFL). Additionally, via communication network(s) 310, ETSCT device 302 may respectively receive and transmit data from and to one or more from among client devices 304(1)-304(n) and the server devices 306(1)-306(n).

However, FIG. 3 depicts the first client device 304(1) and the second client device 304(2) as belonging to communication network(s) 310, and ETSCT device 302 may communicate with any one or more devices or apparatuses that belong to the communication network(s) 310, such as one or more from among client devices 304(1)-304(n). For example, ETSCT device 302 may utilize a graphical user interface (GUI) to communicate with one or more from among client devices 304(1)-304(n), and communication network(s) 310 may comprise a cluster that belongs to the above-mentioned enterprise that may be secured from eavesdropping. In a further embodiment, communication network(s) 310 may comprise a cluster of distributed applications that belong to the enterprise.

The first client device 304(1) may be, for example, a smart phone. Of course, the first client device 304(1) may be any additional device described herein. The second client device 204(2) may be, for example, a personal computer (PC). Of course, the second client device 204(2) may also be any additional device described herein.

The client devices 204(1)-204(n) may represent, for example, computer systems of the enterprise's client network. The first client device 204(1) may represent, for example, one or more computer systems of a client or of a cluster of clients within the enterprise or client network. Of course, the first client device 204(1) may include one or more of any of the devices described herein. The second client device 204(2) may be, for example, one or more computer systems of another client or cluster of clients within the enterprise or client network. Of course, the second client device 204(2) may include one or more of any of the devices described herein.

The process may be executed via the communication network(s) 310, which may comprise plural networks as described above. For example, in an embodiment, either or both of the first client device 204(1) and the second client device 204(2) may communicate with the ETSCT device 302 via broadband or cellular communication. Of course, these embodiments are merely exemplary and are not limiting or exhaustive.

Electronic transmission structure conformity tool module 314 may programmatically configure and communicate with server devices 306(1)-306(n), which may respectively correspond to remote clusters of server devices, such as a server farm, for example.

Electronic transmission structure conformity tool module 314 may execute a process that programmatically configures and communicates with one or more server devices from among server devices 306(1)-306(n). In some embodiments, at least one from among server devices 306(1)-306(n) may comprise a processing platform.

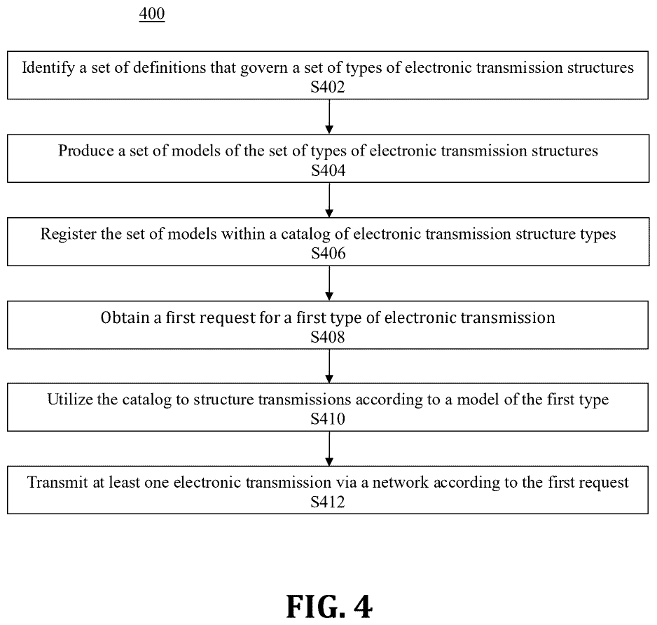

A process for an electronic transmission structure conformity tool is generally indicated at flowchart 400 in FIG. 4, and this electronic transmission structure conformity tool may comprise the Picture It module and/or the suite of data modeling governance tools, which are both discussed in further detail below.

Process 400 may be utilized to produce electronic transmission structures that meet at least one electronic transmission network's structural requirements. In process 400, transmission type-based structural conformity may be provided to electronic transmissions within the at least one electronic transmission network by implementing an electronic transmission structure conformity tool which ensures that electronic transmissions meet the at least one electronic transmission network's structural requirements for electronic transmissions.

At step S402, an electronic transmission structure conformity tool (such as electronic transmission structure conformity tool 202, electronic transmission structure conformity tool device 302 and/or electronic transmission structure conformity tool module 314) may identify a set of definitions that govern a set of electronic transmission structure types. The set of definitions may define (or correspond to) a particular predefined protocol, such as an application program interface (API) protocol. Accordingly, the set of definitions may define (or correspond to) one or more API protocols, which may include one or more public APIs, such as Open API.

The set of definitions may also (or alternatively) comprise a plurality of subsets of definitions, and the set (and/or each subset) of definitions may comprise at least one from among a naming convention definition, a required access permission definition, and a transmission retention duration definition.

The set of definitions may be identified from a set of governing documents that dictate (and/or govern) operating parameters of the at least one electronic transmission network. Prior to step S402, during a provisional stage of process 400, a record module of the electronic transmission structure conformity tool may record each document from among the set of governing documents into at least one network operations records repository, such as network operations records repository 312.

During, before and after each stage of process 400, the electronic transmission structure conformity tool's record module may keep the at least one network operations records repository up to date by recording at least one new (and/or updated) governing document into the at least one network operations records repository after the at least one new (and/or updated) governing document is completed. The electronic transmission structure conformity tool may be configured to store/record the set of governing documents within network operations records repository 312 as a set of respectively corresponding Java Archive (JAR) files that reflect the set of governing documents'respectively corresponding contents.

The electronic transmission structure conformity tool may be configured to utilize optical character recognition (OCR) to store/record the set of governing documents. Additionally, the electronic transmission structure conformity tool may also (or alternatively) be configured to utilize artificial intelligence and/or machine learning (AI/ML) to store/record the set of governing documents. Moreover, the electronic transmission structure conformity tool may also (or alternatively) be configured to store/record the set of governing documents by generating an image of the set of governing documents.

At step S402, the electronic transmission structure conformity tool may identify the set of definitions by utilizing one or more technique from among the following processing techniques: word processing, optical character recognition (OCR), and artificial intelligence and/or machine learning (AI/ML) that may include natural language processing (NLP).

At step S404, the electronic transmission structure conformity tool may produce a set of respectively corresponding models of a set of electronic transmission structure types that are required to ensure interoperability to each hardware and/or software component within the at least one electronic transmission network. In other words, the electronic transmission structure conformity tool maintains interoperability between the components of the at least one electronic transmission network by ensuring that each electronic transmission that these components generate, conforms to at least one applicable electronic transmission structure requirement from among the set of electronic transmission structure types.

Hence, the electronic transmission structure conformity tool may improve electronic transmission networks by ensuring that each of its electronic transmissions conform to an applicable electronic transmission structure requirement from among the set of electronic transmission structure types. Accordingly, hardware, software and/or counterpart networks that are incompatible with an electronic transmission network may employ an electronic transmission structure conformity tool to seamlessly integrate into the electronic transmission network and utilize the electronic transmission network's resources.

The electronic transmission structure conformity tool may utilize a data modeling tool to perform the operations of step S404. The electronic transmission structure conformity tool (or the data modeling tool) may utilize JavaScript object notation (JSON) to produce the set of respectively corresponding models. The set of respectively corresponding models may identify a set of respectively corresponding structural parameters of the at least one electronic transmission network's electronic transmissions.

The set of electronic transmission structure types may comprise a plurality of subsets (or sets) of electronic transmission structure types, such as a first, second, third and/or fourth set of electronic transmission structure types. The first set of electronic transmission structure types, the second set of electronic transmission structure types, the third set of electronic transmission structure types, and the fourth set of electronic transmission structure types may identify structural parameters that respectively correspond to application programing interface (API) transmissions, file transmissions, user interface (UI) transmissions, media transmissions, hypertext transfer protocol (HTTP) transmissions, and transmission control protocol (TCP) transmissions.

At step S406, the electronic transmission structure conformity tool may register the set of respectively corresponding models within an enterprise-wide catalog of electronic transmission structure types, such as catalog of transmission structure models 308. The enterprise-wide catalog of electronic transmission structure types may include a distributed catalog of transmission structure models, and the distributed catalog may be distributed throughout an enterprise's network and/or the at least one electronic transmission network.

During the registration of step S406, the electronic transmission structure conformity tool may complete its registration by publishing the set of respectively corresponding models to at least one from among an external schema and a public schema. For the purposes of the present disclosure, the term schema refers to a library of definitions of the various relationships that various tables (such as the set of respectively corresponding models) have with one another. Accordingly, the at least one from among the external schema and the public schema may be utilized by an external network or component that cannot access the enterprise-wide catalog of electronic transmission structure types.

Accordingly, at least one external electronic transmission network process may utilize the at least one from among the external schema and the public schema to structure (or generate) electronic transmissions. Subsequently, the at least one external electronic transmission network process may transmit the electronic transmissions to the at least one electronic transmission network, and the electronic transmission structure conformity tool may subsequently receive the electronic transmissions transmitted from the at least one external network process.

At step S408, the electronic transmission structure conformity tool may obtain a first request for a first type of electronic transmission, and the set of respectively corresponding models may include a first model of the first type of the electronic transmission. The electronic transmission structure conformity tool may obtain (or receive) the first request from an input.

At step S410, the electronic transmission structure conformity tool may utilize the enterprise-wide catalog of electronic transmission structure types to structure the electronic transmission according to the first model of the first type of the electronic transmission. At step S410, the electronic transmission structure conformity tool may structure the electronic transmission by generating it according to the structural parameters that correspond to the first type of the electronic transmission.

At step S412, the electronic transmission structure conformity tool may transmit the electronic transmission according to the first request via the at least one electronic transmission network.

Accordingly, process 400 may be utilized to provide transmission type-based structural conformity to electronic transmissions within at least one electronic transmission network and, thereby, to improve the at least one electronic transmission network by implementing an electronic transmission structure conformity tool which ensures that electronic transmissions meet the at least one electronic transmission network's structural requirements.

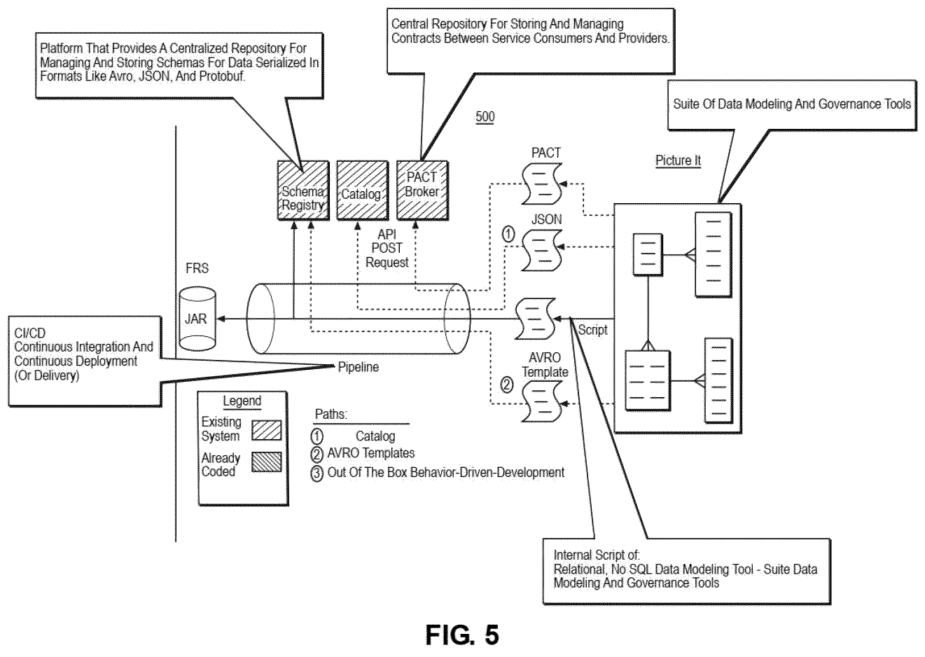

A diagram of an environment for a pipeline of an electronic transmission structure conformity tool is generally indicated at 500 in FIG. 5.

According to FIG. 5, electronic transmission structure conformity tool environment 500 may also be utilized to produce electronic transmission structures that meet at least one electronic transmission network's structural requirements. Thereby, transmission type-based structural conformity may be provided to electronic transmissions within the at least one electronic transmission network by implementing electronic transmission structure conformity tool environment 500, which ensures that electronic transmissions meet the at least one electronic transmission network's structural requirements for electronic transmissions.

In FIG. 5, electronic transmission structure conformity tool environment 500 is depicted as including a module labeled “Picture It,” which may comprise a suite of data modeling and governance tools. The “Picture It” module may output various types of data models, such as PACT (people, activities, contexts, technologies) data structure model(s), JavaScript object notation (JSON) data model(s), and Apache Avro template model(s).

As illustrated in FIG. 5, the Picture It module may output these various models (which may include an actual visual depiction) of respectively corresponding types of data, and these files output by the Picture It module may then be utilized as input into a continuous integration and continuous deployment or delivery (CI/CD) pipeline. As depicted, the CI/CD pipeline may store schema (from Picture It) within a schema registry, which may include a platform that provides a centralized repository for managing and storing schemas for data serialized in formats like Avro, JSON, and protocol buffers (Protobuf). For the purposes of this disclosure “Protobuf” refers to an open-source protocol for serializing structured data.

FIG. 5 also illustrates that the CI/CD pipeline may store models (from Picture It) within a Catalog and/or a PACT Broker, which is a central repository for storing and managing contracts between service consumers and providers. Additionally, electronic transmission structure conformity tool environment 500 is also depicted as including a Functional Requirements Specification (FRS) database, which may utilize a Java ARchive (JAR) file format to store each model/file that is output by Picture It.

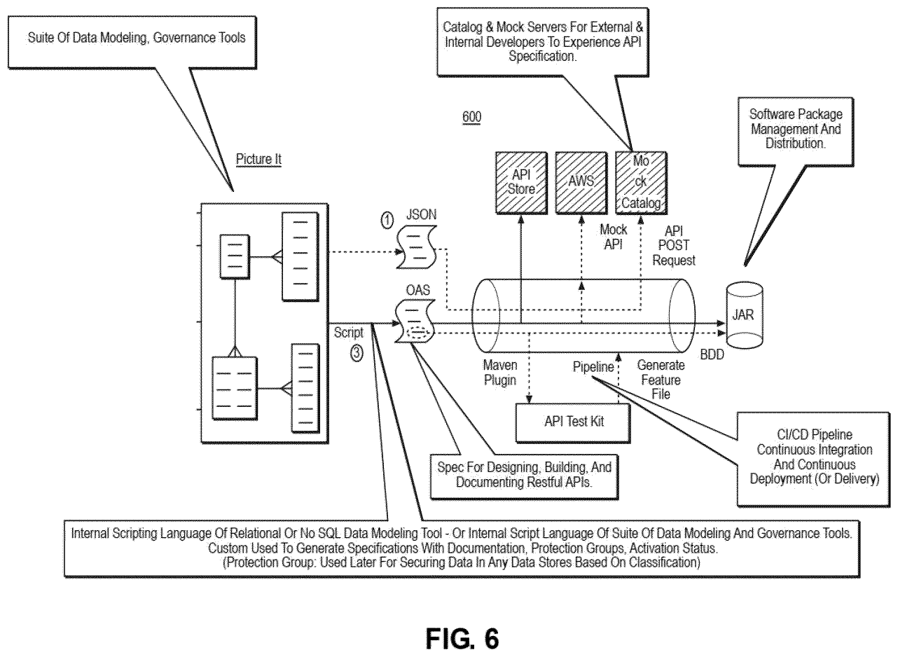

A diagram of another aspect of an environment for a pipeline of an electronic transmission structure conformity tool is generally indicated at 600 in FIG. 6.

According to FIG. 6, electronic transmission structure conformity tool environment 600 may also be utilized to produce electronic transmission structures that meet at least one electronic transmission network's structural requirements. Thereby, transmission type-based structural conformity may be provided to electronic transmissions within the at least one electronic transmission network by implementing electronic transmission structure conformity tool environment 600, which ensures that electronic transmissions meet the at least one electronic transmission network's structural requirements for electronic transmissions.

In FIG. 6, electronic transmission structure conformity tool environment 600 is depicted as comprising the topology of electronic transmission structure conformity tool environment 500. In FIG. 6, the “Picture It” module is depicted as outputting at least one JSON model and at least one OpenAPI Specification (OAS) model to the pipeline of electronic transmission structure conformity tool environment 600.

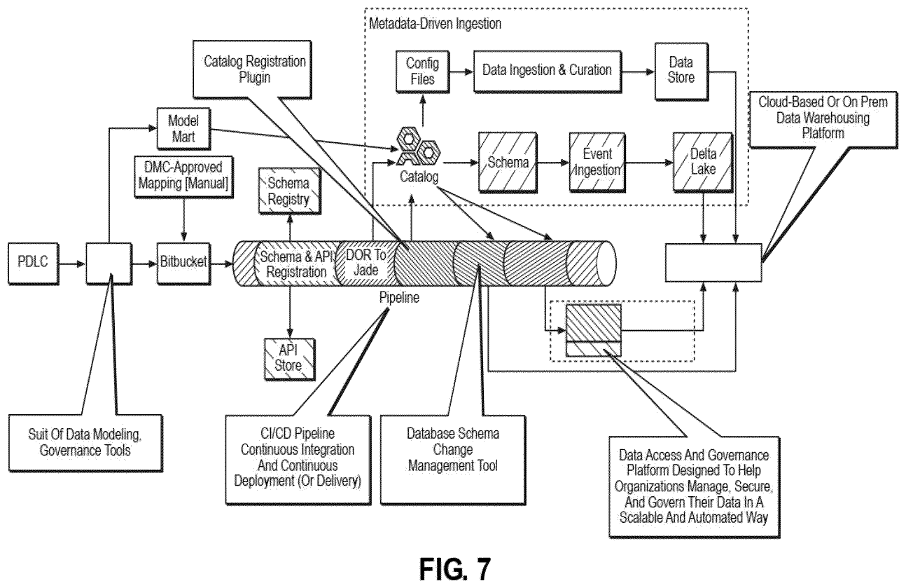

A diagram of details of an environment for a pipeline of an electronic transmission structure conformity tool is generally indicated at 700 in FIG. 7.

According to FIG. 7, electronic transmission structure conformity tool environment 700 may also be utilized to produce electronic transmission structures that meet at least one electronic transmission network's structural requirements. Thereby, transmission type-based structural conformity may be provided to electronic transmissions within the at least one electronic transmission network by implementing electronic transmission structure conformity tool environment 700, which ensures that electronic transmissions meet the at least one electronic transmission network's structural requirements for electronic transmissions.

In FIG. 7, electronic transmission structure conformity tool environment 700 is depicted as utilizing output from a program development life cycle (PDLC) module, as an input to a suite of data modeling and governance tools. Electronic transmission structure conformity tool environment 700 is also depicted as utilizing output from the suite of data modeling and governance tools, as an input to at least one from among: (1) a Bitbucket module, which may utilize a data management center (DMC)-approved mapping manual to provide the input to a CI/CD pipeline; and (2) a Model Mart module, which may provide the suite's input to a Metadata-Driven Ingestion process.

FIG. 7 also depicts electronic transmission structure conformity tool environment 700 as configured for its Bitbucket module to utilize at least one DMC-approved mapping manual register to register the suite's output to at least one from among a schema registry and an API store. Subsequently, a disaggregated open router (DOR) may route the CI/CD pipeline's data/files to a Java agent development (JADE) framework, which is a framework for developing Java-based software agents. The CI/CD pipeline may also include a database schema change management tool, which is a tool for managing database schema changes.

According to FIG. 7, the CI/CD pipeline may output at least one data access and governance platform designed to help organizations manage, secure, and govern their data in a scalable manner. At least one from among the output of the CI/CD pipeline and the output of the Metadata-Driven Ingestion process, may be transmitted as input to at least one cloud-based or on-premise data warehouse platform.

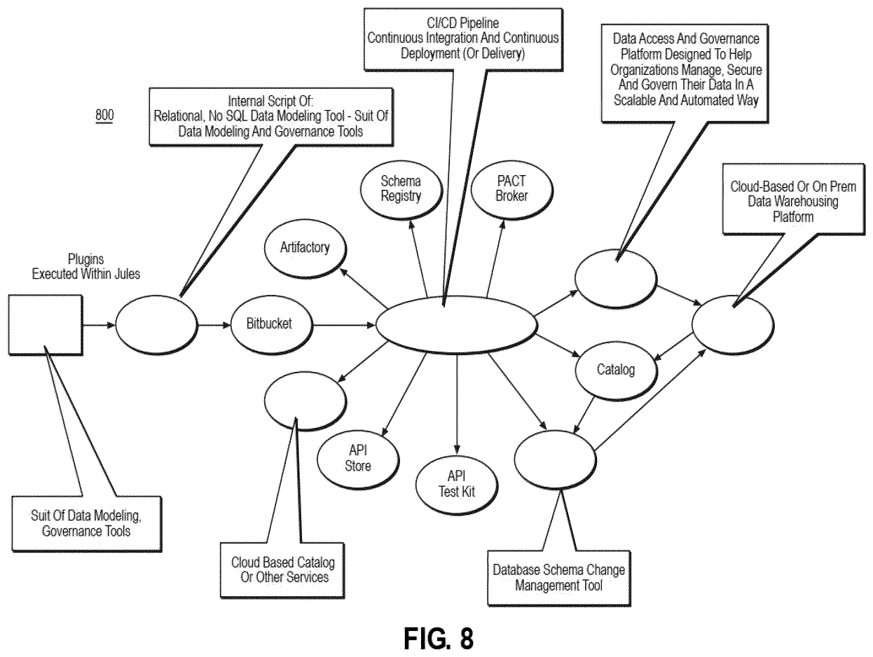

A map of details for a pipeline of an electronic transmission structure conformity tool is generally indicated at 800 in FIG. 8.

According to FIG. 8, electronic transmission structure conformity tool environment pipeline map 800 may be utilized to produce electronic transmission structures that meet at least one electronic transmission network's structural requirements. Thereby, transmission type-based structural conformity may be provided to electronic transmissions within the at least one electronic transmission network by implementing electronic transmission structure conformity tool environment pipeline map 800, which ensures that electronic transmissions meet the at least one electronic transmission network's structural requirements for electronic transmissions.

In FIG. 8, electronic transmission structure conformity tool environment pipeline map 800 is depicted as comprising a suite of data modeling governance tools that may be implemented via plugins that are executed within Jules (although such plugins may also/instead be executed within Jenkins). For the purposes of the present disclosure, the term “Jules” is understood to refer to an open-source CI/CD-based automation server that streamlines electronic deployments. For the purposes of the present disclosure, the term “Jenkins” is understood to refer to a similar open-source CI/CD-based automation server that streamlines electronic deployments.

FIG. 8 also depicts electronic transmission structure conformity tool environment pipeline map 800 as utilizing an output (namely, an internal script) of the suite of data modeling governance tools, as input to a Bitbucket module which may provide the internal script as input to a CI/CD pipeline, such as the CI/CD pipelines mentioned above. Subsequently, the CI/CD pipeline may register the internal script within at least one of a plurality of repositories that may comprise an artifactory repository, a schema registry repository, a PACT broker repository, a catalog repository, an API test kit repository, an API store repository, a database schema change management tool repository, a cloud-based catalog or other services repository, a cloud-based or on prem data warehousing platform repository, and a data access and governance platform repository that helps organizations manage, secure and govern their data in a scalable and automated way.

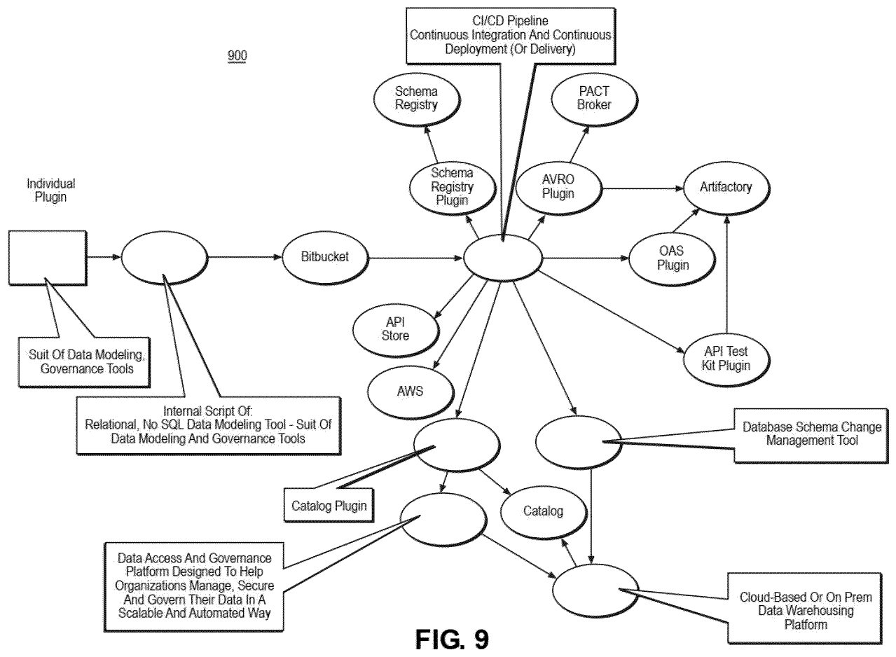

A map that illustrates other details for a pipeline of an electronic transmission structure conformity tool is generally indicated at 900 in FIG. 9.

According to FIG. 9, electronic transmission structure conformity tool environment pipeline map 900 may be utilized to produce electronic transmission structures that meet at least one electronic transmission network's structural requirements. Thereby, transmission type-based structural conformity may be provided to electronic transmissions within the at least one electronic transmission network by implementing electronic transmission structure conformity tool environment pipeline map 900, which ensures that electronic transmissions meet the at least one electronic transmission network's structural requirements for electronic transmissions.

In FIG. 9, electronic transmission structure conformity tool environment pipeline map 900 is depicted as comprising a suite of data modeling governance tools that may be implemented via individual plugins. FIG. 9 also depicts electronic transmission structure conformity tool environment pipeline map 900 as utilizing an output (namely, an internal script) of the suite of data modeling governance tools, as input to a Bitbucket module which may provide the internal script as input to a CI/CD pipeline, such as the CI/CD pipelines mentioned above.

Subsequently, the CI/CD pipeline may register the internal script within at least one of a plurality of repositories via an API store repository, Amazon web services (AWS), an intermediary of a schema registry repository (namely, a schema registry plugin), an intermediary of a PACT broker repository (namely, an Avro plugin which may also serve as an intermediary of an Artifactory repository), an intermediary of an artifactory repository (such as, an OAS plugin and/or an API test kit plugin), and an intermediary of a catalog repository—such as (1) a catalog plugin, (2) a database schema change management tool and a cloud-based or on prem data warehousing platform, and (3) a catalog plugin, data access and governance platform, and a cloud-based or on prem data warehousing platform.

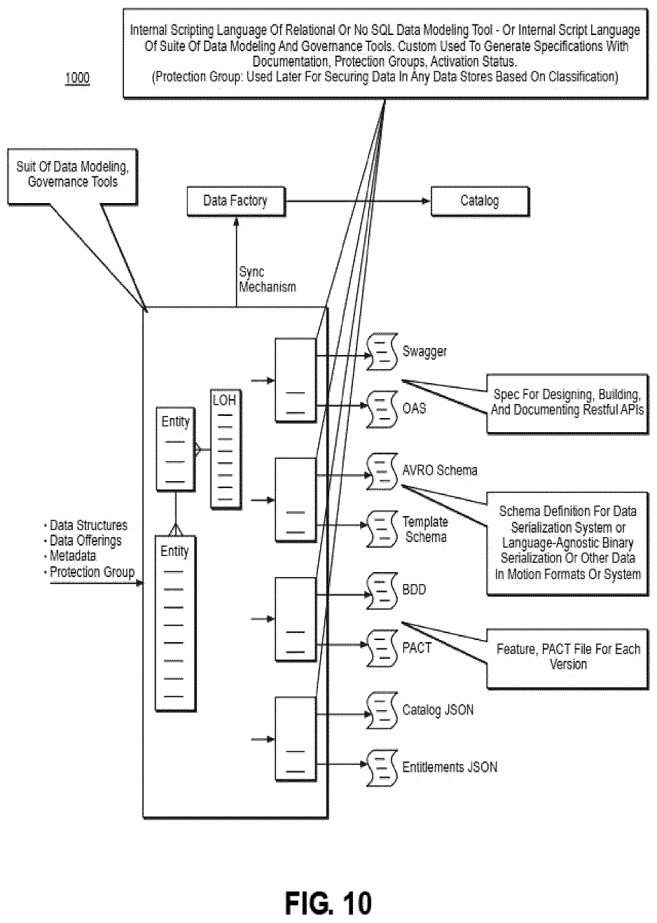

A diagram of an electronic transmission structure conformity tool module is generally indicated at 1000 in FIG. 10.

According to FIG. 10, electronic transmission structure conformity tool module 1000 may be utilized to produce electronic transmission structures that meet at least one electronic transmission network's structural requirements. Thereby, transmission type-based structural conformity may be provided to electronic transmissions within the at least one electronic transmission network by implementing electronic transmission structure conformity tool module 1000, which ensures that electronic transmissions meet the at least one electronic transmission network's structural requirements for electronic transmissions.

In FIG. 10, electronic transmission structure conformity tool module 1000 may output various models that define at least one from among data structures, data offerings, metadata, and protection groups. Electronic transmission structure conformity tool module 1000 may output at least one respectively corresponding model for each data structure among a plurality of data structures that may comprise at least one from among Swagger (i.e., an open-source framework that helps developers design, build, document, and test RESTful APIs) data, OAS data, AVRO schema data, template schema data, behavior-driven development (BDD) data, PACT data, catalog JSON data, entitlements JSON data, etc.

FIG. 10 also depicts electronic transmission structure conformity tool module 1000 as including a sync mechanism that is coupled to a data factory that outputs data to a catalog.

Although the invention has been described with reference to several embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed, rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for providing transmission type-based structural conformity to electronic transmissions within at least one electronic transmission network, the method comprising:
identifying a first set of definitions that govern a first set of electronic transmission structure types;
producing a first set of respectively corresponding models of the first set of electronic transmission structure types; and
registering the first set of respectively corresponding models within an enterprise-wide catalog of electronic transmission structure types.

2. The method of claim 1, further comprising:
obtaining a first request for a first type of at least one electronic transmission, wherein the first set of respectively corresponding models comprises a first model of the first type of the at least one electronic transmission;
utilizing the enterprise-wide catalog of electronic transmission structure types to structure the at least one electronic transmission according to the first model of the first type of the at least one electronic transmission; and
transmitting, according to the first request, the at least one electronic transmission via the at least one electronic transmission network.

3. The method of claim 1, wherein the registering comprises:
publishing the first set of respectively corresponding models to at least one from among a public schema and an external schema,
wherein at least one external electronic transmission network process utilizes the at least one from among the public schema and the external schema to structure at least one corresponding electronic network transmission according to the first model of the first type of the at least one electronic transmission; and
receiving the at least one corresponding electronic network transmission from the at least one external electronic transmission network process.

4. The method of claim 1, wherein the first set of respectively corresponding models comprises a first set of definitions that govern a first set of at least one type of electronic transmission structure from among the following electronic transmission structure types: an application programing interface (API) transmission, a file transmission, a user interface (UI) transmission, a media transmission, a hypertext transfer protocol (HTTP) transmission, and a transmission control protocol (TCP) transmission.

5. The method of claim 1, wherein the first set of definitions comprises at least one from among a naming convention definition, a required access permission definition, and a transmission retention duration definition.

6. The method of claim 1, wherein the producing comprises:
utilizing at least one data modeling tool to produce the first set of respectively corresponding models of the first set of electronic transmission structure types.

7. The method of claim 6, wherein the at least one data modeling tool is configured to utilize JavaScript object notation (JSON) to produce the first set of respectively corresponding models.

8. The method of claim 1, wherein the first set of definitions is obtained from at least one relational database that stores a first set of Java ARchive (JAR) files that provide a first set of respectively corresponding records that collectively govern at least one operation of the at least one electronic transmission network.

9. The method of claim 1, wherein the first set of definitions corresponds to a public application programing interface (API) protocol.

10. The method of claim 1, further comprising:
receiving at least one from among a new definition and an updated definition, that comprises at least one modification to the first set of definitions that govern the first set of electronic transmission structure types; and
utilizing the at least one from among the new definition and the updated definition, to incorporate the at least one modification into the first set of respectively corresponding models of the first set of electronic transmission structure types.

11. A system for providing transmission type-based structural conformity to electronic transmissions within at least one electronic transmission network, the system comprising:
a processor; and
memory storing instructions that, when executed by the processor, cause the processor to perform operations comprising:
identifying a first set of definitions that govern a first set of electronic transmission structure types;
producing a first set of respectively corresponding models of the first set of electronic transmission structure types; and
registering the first set of respectively corresponding models within an enterprise-wide catalog of electronic transmission structure types.

12. The system of claim 11, wherein when executed, the instructions cause the processor to perform further operations comprising:
obtaining a first request for a first type of at least one electronic transmission, wherein the first set of respectively corresponding models comprises a first model of the first type of the at least one electronic transmission;
utilizing the enterprise-wide catalog of electronic transmission structure types to structure the at least one electronic transmission according to the first model of the first type of the at least one electronic transmission; and
transmitting, according to the first request, the at least one electronic transmission via the at least one electronic transmission network.

13. The system of claim 11, wherein when the instructions are executed by the processor, the registering comprises:
publishing the first set of respectively corresponding models to at least one from among a public schema and an external schema,
wherein at least one external electronic transmission network process utilizes the at least one from among the public schema and the external schema to structure at least one corresponding electronic network transmission according to the first model of the first type of the at least one electronic transmission; and
receiving the at least one corresponding electronic network transmission from the at least one external electronic transmission network process.

14. The system of claim 11, wherein when the instructions are executed by the processor, the first set of respectively corresponding models is configured to comprise a first set of definitions that govern a first set of at least one type of electronic transmission structure from among the following electronic transmission structure types: an application programing interface (API) transmission, a file transmission, a user interface (UI) transmission, a media transmission, a hypertext transfer protocol (HTTP) transmission, and a transmission control protocol (TCP) transmission.

15. The system of claim 11, wherein when the instructions are executed by the processor, the first set of definitions is configured to comprise at least one from among a naming convention definition, a required access permission definition, and a transmission retention duration definition.

16. The system of claim 11, wherein when the instructions are executed by the processor, the first set of definitions is configured to correspond to a public application programing interface (API) protocol.

17. A non-transitory computer-readable medium for providing transmission type-based structural conformity to electronic transmissions within at least one electronic transmission network, the computer-readable medium storing instructions that, when executed by a processor, cause the processor to perform operations comprising:
identifying a first set of definitions that govern a first set of electronic transmission structure types;
producing a first set of respectively corresponding models of the first set of electronic transmission structure types; and
registering the first set of respectively corresponding models within an enterprise-wide catalog of electronic transmission structure types.

18. The computer-readable medium of claim 17, wherein when executed, the instructions cause the processor to perform further operations comprising:
obtaining a first request for a first type of at least one electronic transmission, wherein the first set of respectively corresponding models comprises a first model of the first type of the at least one electronic transmission;
utilizing the enterprise-wide catalog of electronic transmission structure types to structure the at least one electronic transmission according to the first model of the first type of the at least one electronic transmission; and
transmitting, according to the first request, the at least one electronic transmission via the at least one electronic transmission network.

19. The computer-readable medium of claim 17, wherein when the instructions are executed by the processor, the producing comprises:
utilizing at least one data modeling tool to produce the first set of respectively corresponding models of the first set of electronic transmission structure types,
wherein the at least one data modeling tool is configured to utilize JavaScript object notation (JSON) to produce the first set of respectively corresponding models.

20. The computer-readable medium of claim 17, wherein when executed, the instructions cause the processor to perform further operations comprising:
receiving at least one from among a new definition and an updated definition, that comprises at least one modification to the first set of definitions that govern the first set of electronic transmission structure types; and
utilizing the at least one from among the new definition and the updated definition, to incorporate the at least one modification into the first set of respectively corresponding models of the first set of electronic transmission structure types.
